(19) United States
(12) Patent Application Publication
(10) Pub. No.: US 2007/0118429 A1
(43) Pub. Date: May 24, 2007

(54) SYSTEM AND METHOD FOR PRODUCT TRACKING AND MAPPING

(76) Inventor: Guido Subotovsky, Suffern, NY (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/164,269

(22) Filed: Nov. 16, 2005

(51) Int. Cl. G06Q 30/00

(52) U.S. Cl. 705/26

(57) ABSTRACT

A system and method of providing a map for locating or finding a product in a store are provided. User information identifying the product is received at a kiosk or user terminal in the store, product location information is retrieved by a server or central node from an inventory table based on the information identifying the product, approximate coordinates for the product are determined based on the product location information with reference to a store layout design, and the approximate coordinates are plotted on the map. The store may be a retail store, a warehouse or a commercial dealership. The approximate coordinates for the product may be determined in batch at a time before receiving the information identifying the product.

### FIELD OF THE INVENTION

The present invention relates to tracking products and inventories at individual retail stores/outlets, and more particularly, to an network and/or client/server-based system, medium and method for enhancing the customer's shopping experience at retail or other stores by generating a map to facilitate the consumer's ability to find and access desired products.

### BACKGROUND OF THE INVENTION

The proliferation of large department stores, super mega-stores, e.g., Target, Lowe's, Wal-Mart, and large supermarkets having many different products for sale have made it difficult for shoppers to find particular items. While such stores may provide a store directory, e.g., in the form of large print signs associated with store aisles, departments or particular areas where specific products or product types reside, consumers (shoppers) often times still find it difficult to locate a specific product.

Systems have been proposed that provide information to consumers for finding shops or what products are sold in shops. Fargo, U.S. Patent Application Publication No. 2005/0097005 provides an internet-based approach that allows shoppers to find stores that sell products or services they desire in their neighborhood based on inventory information provided by the businesses. However, Fargo does not address finding products or items in a store, accessing a store's inventory data about the location, department or aisle number of a product inside the store, or providing information about the layout of a store and product location in the store to a customer.

While simple solutions such as querying a store clerk or manager may lead to the location of a specific product, it is oftentimes difficult to find such a person. For example, in such large stores with many departments and shoppers, a worker may be helping several customers at once, and vying for the attention of a store clerk or worker, in such situations is difficult if not impossible. Moreover, even when engaging a clerk or worker, that employee may be familiar only with specific department locations containing specific product types, often leading the shopper to a wrong area or product aisle or area of the store.

Further, requiring employees to spend time directing shoppers to products can detract from the employees' other duties and consume valuable company time.

It would be highly desirable to provide a shopping system and method that facilitates the customers' ability quickly to identify and locate particular products in such large super stores or other shopping environments.

### BRIEF SUMMARY OF THE INVENTION

A system and method of providing a map for locating a product in a store are provided. The method comprises the following: receiving from a user information identifying the product, retrieving product location information from an inventory table based on the information identifying the product, determining approximate coordinates for the product based on the product location information with reference to a store layout design, and plotting the approximate coordinates on the map, and displaying the map to the user.

The store may be a retail store, a warehouse or a commercial dealership (such as a wholesaler, shipping company, distributor, or the like).

Each entry of the inventory table may be indexed on a product ID. The product location information may identify a department and a reference within the department. The entry of the inventory table may include the product location information, the product location information identifying a zone for the product, such that approximate coordinates are determined based on the zone for the product. Upon receiving the information identifying the product, it may be transmitted to a server that retrieves the product location information and determines the approximate coordinates for the product.

Further, the approximate coordinates for the product may be determined in batch at a time before receiving the information identifying the product.

### BRIEF DESCRIPTION OF THE DRAWINGS

FIG. 1 is schematic diagram of a product locator engine 10 according to an aspect of the present invention.

FIG. 2 illustrates a map of a store with product locations according to an aspect of the present invention.

FIG. 3 illustrates a map of a particular retail department store with product locations according to an aspect of the present invention.

FIG. 4 illustrates data entry and selection for user interaction with a system according to an aspect of the present invention.

FIG. 5 illustrates data entry and selection, including a department selection scroll menu for user interaction with a system according to an aspect of the present invention.

FIG. 6 illustrates data entry and selection, including a product list, according to an aspect of the present invention.

FIG. 7 illustrates product selection, including a dialog box, according to an aspect of the present invention.

FIG. 8 illustrates data entry and selection, including a product list, according to an aspect of the present invention.

FIG. 9 illustrates data entry and selection, including a department selection scroll menu, according to an aspect of the present invention.

FIG. 10 illustrates a map of a store with product locations according to an aspect of the present invention.

FIG. 11 illustrates system user login to the PLM system according to an aspect of the present invention.

FIG. 12 illustrates system architecture for product searching according to an aspect of the present invention.

FIG. 13 illustrates system architecture for a product list user manipulation according to an aspect of the present invention.

FIG. 14 illustrates system architecture for removing one or more products from a product list according to an aspect of the present invention.

### DETAILED DESCRIPTION OF THE INVENTION

The following discussion describes embodiments of Applicant's invention however, it will be appreciated that numerous modifications of the invention are possible and that the invention may be embodied in other forms and practiced in other ways without departing from the spirit of the invention. Further, features of embodiments described may be omitted, combined selectively or as a whole with other embodiments, or used to replace features of other embodiments, or parts thereof, without departing from the spirit of the invention. The figures and the detailed description are therefore to be considered as an illustrative explanation of aspects of the invention, but should not be construed to limit the scope of the invention. The scope of the invention is defined by the below-set forth claims.

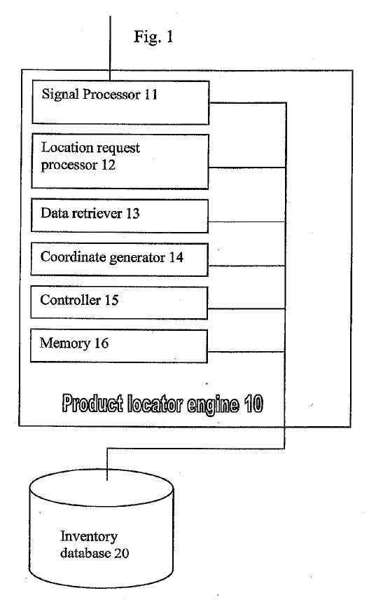

Aspects of the invention will be described with reference to FIG. 1, which is a schematic diagram of a product locator engine 10 according to an embodiment of the present invention. Product locator engine 10 may be embodied as or as part of one or more servers on a network, such as Ethernet, a LAN, a WAN, an intranet or the Internet. The functions of the product locator engine 10 may be performed on store or warehouse premises or off-premises, such as by a server or node at a central location maintained by a vendor to the store of the product locator system. Product locator engine 10 may also be logically or physically coupled to a user kiosk or terminal in the store.

The product locator engine 10 shown in FIG. 1 may include a signal processor 11, that receives and transmits electrical or radio signals to the kiosks or terminals in stores used by shoppers or users. Signal processor 11 may connect to a data network (not shown) via a wired or a wireless connection.

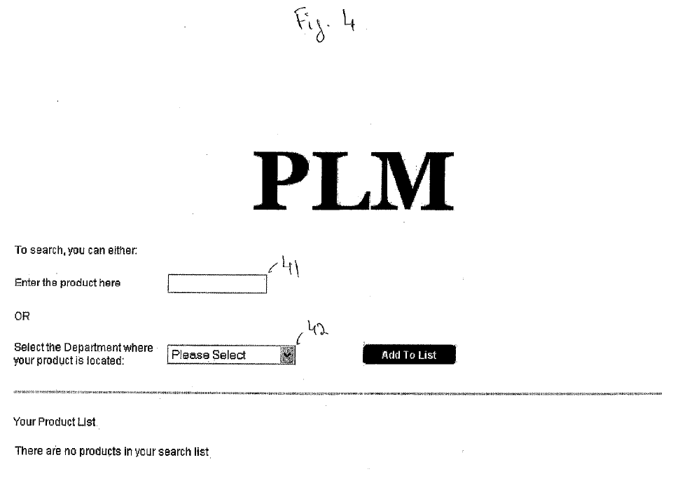

Location request processor 12 receives data from signal processor 11 representing a user request for a product, for example a user request entered via a user interface at a kiosk in the store using a graphical user interface such as shown in FIGS. 4-9. Location request processor 12 passes the product information, or data representing product information such as a product ID or product reference number or the like, to data retriever 13 which retrieves product location information from the inventory database 20 connected to the product locator engine 10 via a wired or wireless connection, for example using a LAN, a WAN, an IP-based network, such as the Internet, or the like. It will be understood that while inventory database 20 is shown in FIG. 1 as being physically separate from the product locator engine 10, the inventory database 20 can be physically integrated with, attached to, or be configured as a module of, the product locator engine 10. Similarly, the product locator engine 10 may be connected to more than one database containing inventory information for products, in addition to inventory database 20. For example, a chain store that includes many branches in different locations or franchises may all be connected via a wired or wireless connection to one or more central nodes, such as the product locator engine 10 and separate databases may be used for one or more of such separate branches or franchises.

Product location information retrieved by data retriever 13 is passed to coordinate generator 14 of the product locator engine 10, where the coordinates, or approximate coordinates for the product in the store are computed (as discussed below) and passed to the kiosk or terminal or the like located in the store.

A memory 16 stores information and settings of the product locator engine 10 and the system. For example, memory 63 may store information necessary to execute instructions of the software modules of the product locator engine 10 and aisle, layout, floor plan, and design information about one or more stores.

The controller 15 coordinates the functioning of the units or modules of the security control node 10. Controller 15 may include an integrated circuit, such as a chip to control the functioning of the keypad as described herein. Controller 15, like other modules of the product locator engine 10 may be configured as hardware, software, firmware, or some combination of the foregoing.

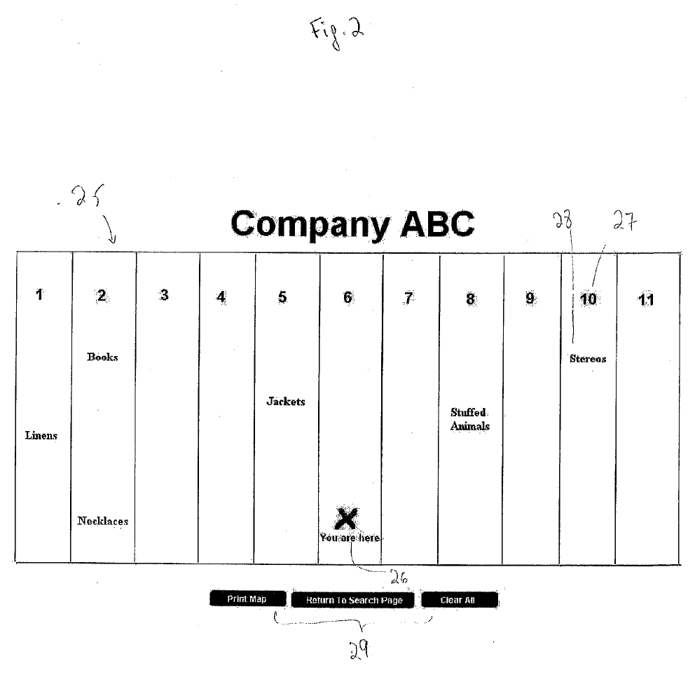

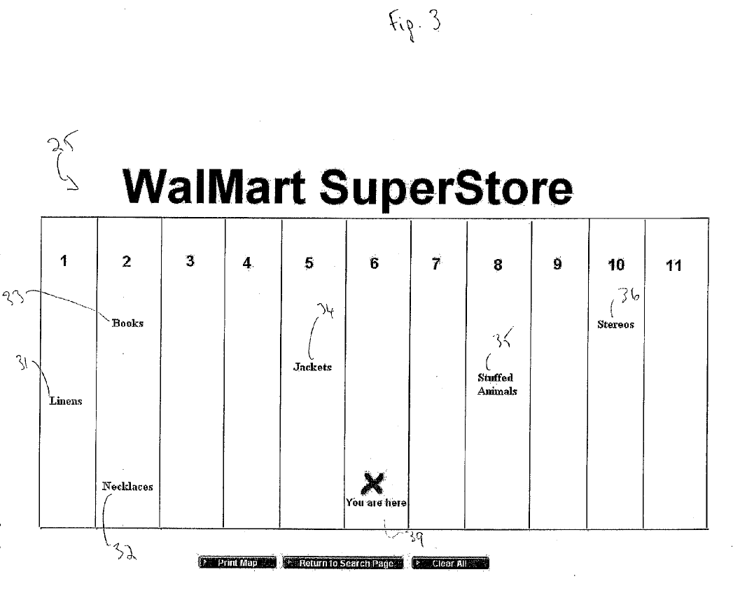

FIGS. 2 and 3 show a map 25 displayed to a customer identifying locations for product categories located in the store in aisles 1-11. FIG. 2 shows an aisle 10, 27, and the product category “Stereos” 28, for which the customer has requested location information in the store. Also, shown in FIG. 2 is a query location 26, a customer interface, for example, a kiosk or data terminal or the like, where product location queries can be made and a map output, printed, or displayed.

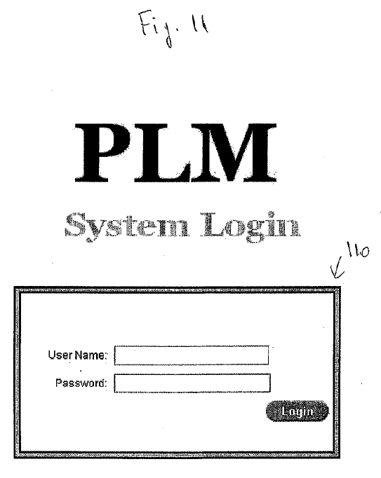

FIG. 11 shows a dialog box 110 to access system information for the product locator machine “PLM”.

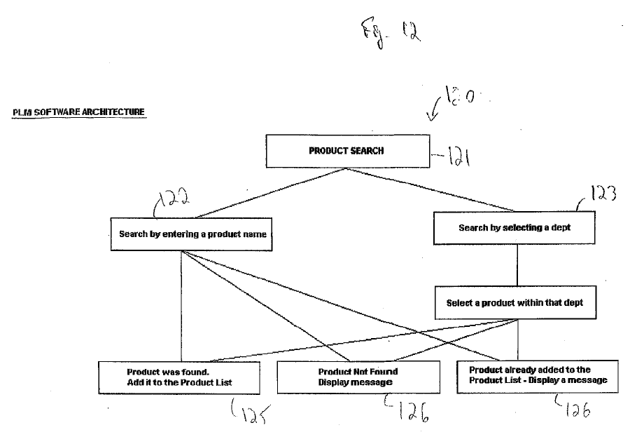

FIG. 12 shows software architecture for the product search functions 120 of the system, according to an aspect of the present invention. Product search 121 may be commenced using a search by selecting a department 123 or a search by entering a product name 122. If the product is found as shown in box 125, the product may be added to the product list, or if the product is already on the product list, as shown in box 127, an appropriate message may be displayed to the customer. As shown in box 126, if a product is not found a message is displayed to the customer accordingly.

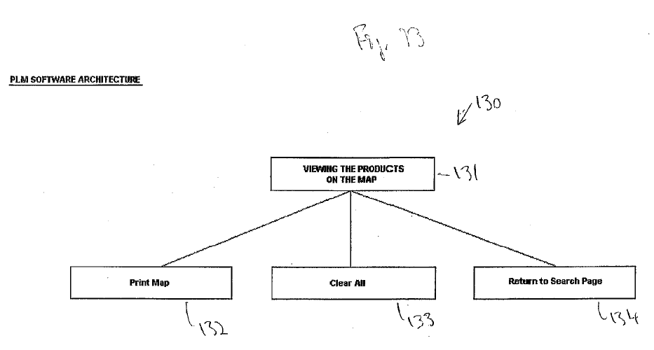

FIG. 13 shows software architecture 130 for viewing products on a map. The viewing products on the map module 131 includes three buttons that may be pressed or otherwise selected, a print map button 132 (to request the outputting of the map with the products on the list), a clear all button 133 (to clear products from the list of products accumulated for the customer), and a return to search page button 134 (to return to searching).

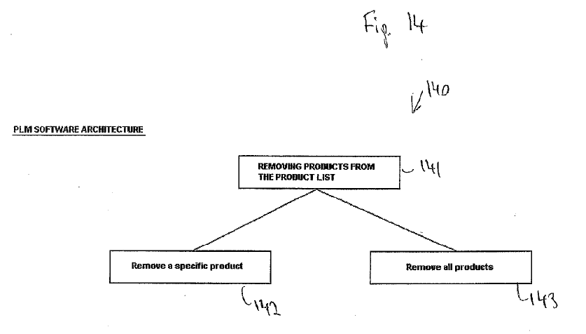

FIG. 14 shows software architecture 140 for removing products from the product list that have been compiled at user requests. Removing products from the product list 141 contains two branches, removing a specific product 142 and removing all products 143.

An operation of a system according to the present invention will now be described with reference to FIGS. 1 and 2-10. It will be understood that the examples provided, including for example the ways in which the customer interacts with the system, are provided to illustrate aspects of the present invention but the present invention can be implemented in many other ways.

A customer wishes to learn about the location of a product in the store. The customer approaches a kiosk or user terminal, automated information booth or the like located in or adjacent to the store and interacts with a graphical user interface or other type of information entry system. FIG. 4 shows a screen shot entitled “PLM” (Product Locator Machine). Box 41 of FIG. 4 is provided for the customer to enter a description of a product sought. The customer can enter the name of an item, such as “stereo” or a more specific description, such as a model number or the like. Also, instead of or in addition to entering a product description, the customer can choose a department using box 42 of FIG. 4 in which the sought item is likely to be found.

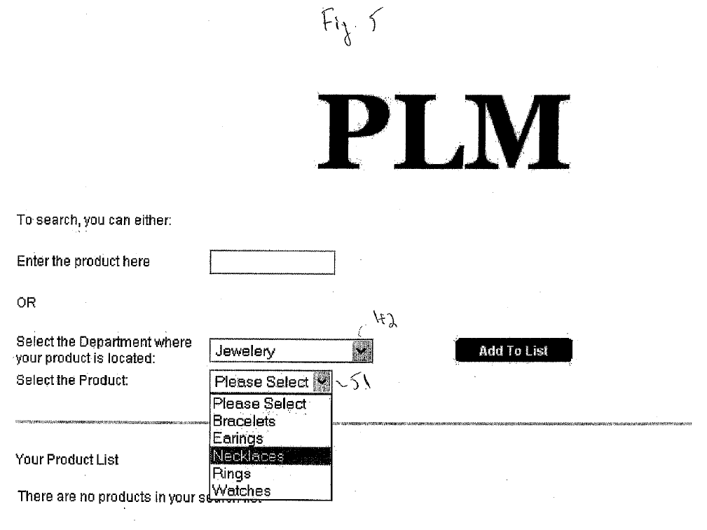

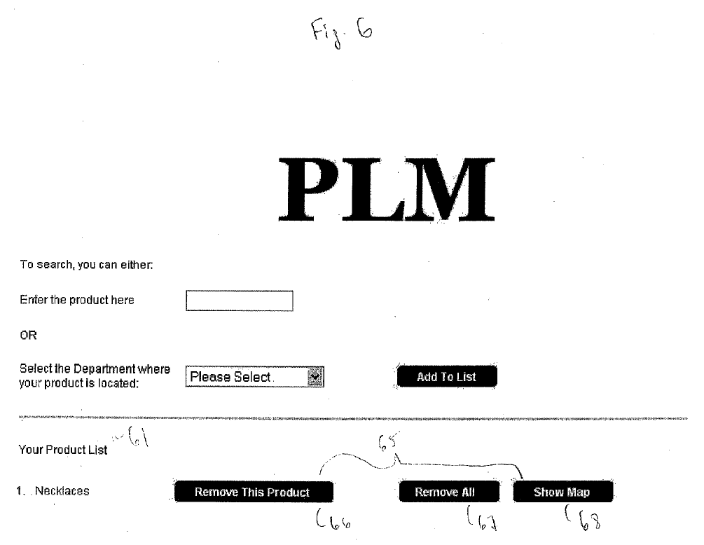

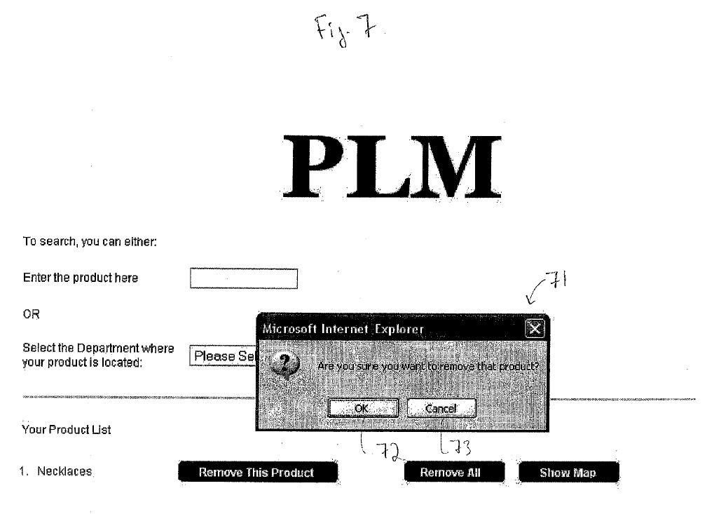

As shown in FIG. 5, the customer in this illustrative example has selected the “Jewelry” Department, and a scroll down menu 51 appears in which the customer chooses a product or product category within the Jewelry Department. Further, as shown in FIG. 5, the customer scrolls down to the product category “Necklaces” of box 51, and the graphical user interface as shown in FIG. 6 shows the customer's product list 61 with the entry Necklaces as entry 1. Immediately next to the entry “Necklaces” of this list, are three buttons 65 which the customer can choose to initiate the following functions: The customer can remove all items from the list using button “Remove All” 67, the customer can request that a map showing the product in the store be generated using the “Show Map” button 68 or the customer can request to remove this product from the customer's product list by clicking or otherwise indicating for selection the “Remove This Product” button 66. Upon selecting the “Remove This Product” button 66, the dialog box 71 appears as shown in FIG. 7. By clicking the “OK” button 72, the item “Necklaces” will be removed from the customer's product list. As discussed, the customer can add products to the list by entering information in field 41 or by using the scroll menu 42 shown in FIG. 4.

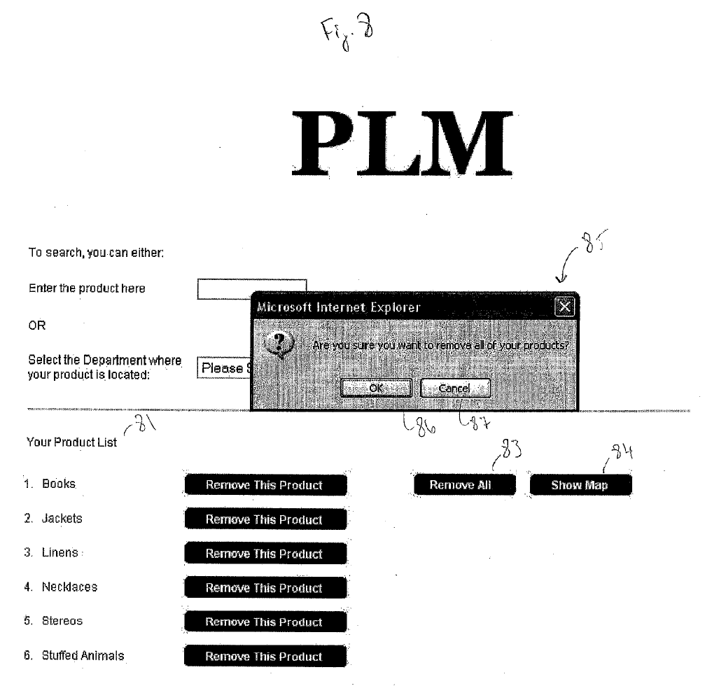

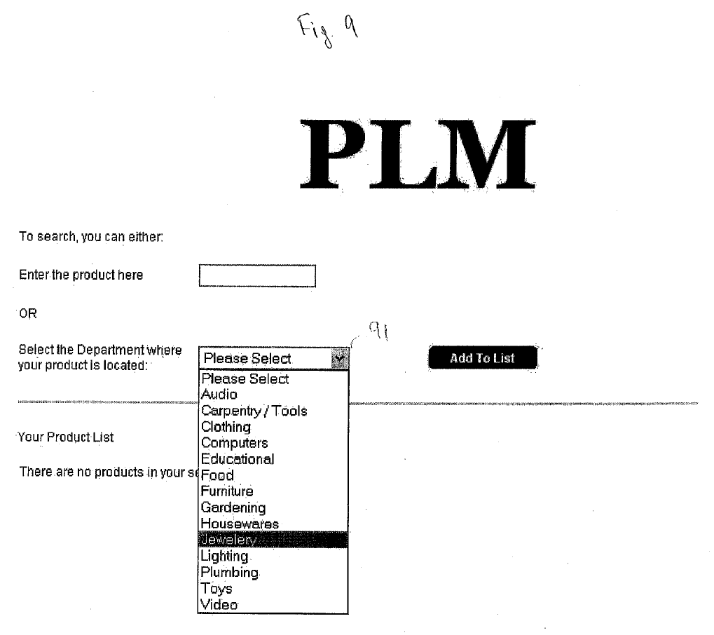

FIG. 8 shows that the customer has accumulated product categories 1-6 for the customer's product list. The customer has selected the “Remove All” button 83 indicating that the customer wishes to remove all six items from the customer's product list. In response, a dialog box appears asking the customer to confirm the decision to remove all. By clicking on the “OK” button 86, all the items are removed and as shown in FIG. 9 the user may wish to select again by clicking on the department selection box 91.

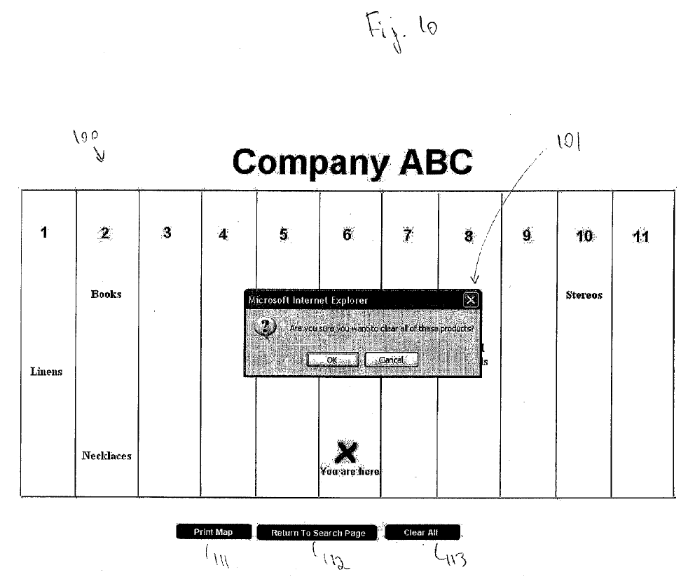

Returning to the customer product list 81 as shown in FIG. 8, the customer may highlight, click on, press, or otherwise select the “Show Map” button 84, and as shown in FIG. 10, a map 100 is generated as will be described below showing locations for each of the six items from the customer product list 81. If the customer wishes to clear all the items for which locations are shown on map 100, the customer may select the “Clear All” button 13. Alternatively, the customer may wish to print the map using “Print Map” button 111 or chooses to conduct a search for a further product or product category by selecting the “Return To Search Page” button 112.

Returning to FIG. 8, if the user selects the “Cancel” button 87 of the dialog box '85, the user can request generation of the product locator map by selecting but then “Show Map” button 84 shown in FIG. 8. At this time, a signal is transmitted to the product locator engine 10 to commence generation of the mapping process for each of the six items on the customer product list 81.

Signal processor 11 of product locator engine 10 shown in FIG. 1 receives data representing the “Books” category of product. The kiosk may access a look-up table to determine a product ID or product number associated with the product or product category selected by the customer, and submit the product ID or product number to the signal processor 11 of the product locator engine 10. Alternatively, the location request processor 12 of the product locator engine 10 may obtain the product ID or product number based on the product or product category received from the kiosk. Location request processor 12 of the product locator engine 10 receives the data from signal processor 11 and passes the product information to data retriever 13. Data retriever 13 interfaces with the inventory database 20 and retrieves product location information from the inventory database.

Inventory database 20 typically stores inventory information about products in a store using a logical table or look-up table (LUT). Entries on such a table may be indexed on product or on product category. Each entry may include product location information consisting of the department, or category of product, and an internal reference within the department more specifically identifying for the subcategory of product within the department a location within the department. In addition to or instead of the department/intra-department reference, each entry may contain a zone identifying the general area for the product in a store. It will be understood however that many other such product location information schemes may be devised to associate a product or product category with location identification information. For example, as will be described in greater detail hereinbelow, each entry may further include x- and y-coordinates for that product when that product is initially added to system and determined based on the product location information with reference to a store layout design. Thus, according to the invention, when entered by the customer, the product may be indicated at that x-coordinate/y-coordinate on the store map as generated for a customer and transmitted to the kiosk.

The product location information extracted from or accessed in inventory database 20 retrieved by data retriever 13 is passed to coordinate generator 14 which generates coordinates or approximate coordinates for the product or product category based on the product location information retrieved. The coordinate generator 14 may refer to information about the design or layout of the store to generate to coordinates. Such store design or layout information may be contained in memory 16 of the product locator engine 10. For example, if the inventory table of the inventory database 20 includes entries for products or product categories identifying the zones in which the product or product category is located, then the design information for the store may include the number of aisles and number of zones in each aisles as corresponding to each isle. Accordingly, if it is known that the store has 25 aisles, and each isle contains four zones, then the location of the zones in the store can be identified accordingly by associating one of four zones to each aisle and associating each of four zones of the isle to an area of the aisle.

According to an aspect of the invention, when a new product is added to the inventory of a department or an existing product is moved to another department, the mapping process updates the system immediately to show, when queried, the product in its location or updated location within the store. For example, the x-coordinate may determine the location of products within an aisle. In such an embodiment, the y-coordinate may correspond to the aisle number or the “width” of the store. Accordingly, a pre-specified value, such as 20, may be added to the highest x coordinate (the x-coordinate with the greatest absolute value) in the department to which the new product is classified, thus placing the new product as the product with the “highest” x-coordinate of that department. It will be understood that values other than 20 may be selected depending on the length of the aisle or number of products of a department, and depending on how the x-coordinates are selected in relation to the y-coordinates for a given application or store. Alternatively, the x-coordinate for other products of the department may be incremented or adjusted to allot an x-coordinate to the new product such that the x-coordinate of the new product is not the highest x-coordinate of the department. Similarly, when an existing product gets moved to a different department, the x-coordinate range of the new department may be incremented to allot an x-coordinate for the moved product.

Coordinate generator 14 may also map the coordinates on a map of the store and transmit them to the user kiosk. Alternatively, as mentioned above, the user kiosk may receive the from the product locator engine 10 only the coordinates or approximate coordinates, and plot the coordinates on a blank map of the store at the kiosk. Thus, in this embodiment, when the user wants to view the map, the program retrieves the x-coordinate and y-coordinate from the database; the x- and y-coordinates for the product having been previously created and stored in the database when the product was initially added to the system and determined based on the product location information with reference to a store layout design.

In one exemplary embodiment, the kiosk may include or may be connected by a wired or wireless connection to a printer with stacks of blank maps pre-printed with the layout and aisles of the store, on which the coordinates or approximate coordinates received from the product locator engine 10 are plotted and/or the names of the desired products, product categories, or product departments are printed and provided to user. For example, as shown in FIG. 3, the names of the six product categories 31-36 can be printed based on the coordinates received on the previously printed map of the store 25. According to an aspect of the present invention, the kiosk receives from the product locator engine 10 a signal indicating which product or product category to print on the previously printed map. The location or approximate location 39 of the user (or the kiosk at which the map is provided) may also be provided on the map 25.

Also, the kiosk may merely provide the map to the user by showing the map on a display integrated with or connected via a wired or wireless connection to the kiosk. Such a display may comprise a CRT screen, flat screen display, a projection device or some other such display suitable to perform the tasks identified herein.

It will be understood that product locator engine 10 may also the located in the store and/or physically integrated with or connected via a wired or wireless connection to the kiosk or terminal located in the store. Also, the coordinate generator 14 may generate in batch in advance the coordinates or approximate coordinates for products of the store based on the inventory information contained in inventory database 20. For example, coordinate generator 14 may generate coordinates for all of the products of the store or for all of the products of the inventory table contained in the inventory database 20, or the coordinate generator 14 may generate coordinates for the most frequently requested or most likely to be frequently requested products or product categories.

Preferred embodiments and methods of the present invention discussed in the foregoing are to be understood as descriptions for illustrative purposes only, and it will be appreciated that numerous changes, substitutions, omissions, and updates thereof are possible without departing from the spirit and scope of the claims.

What is claimed is:

1. A method of providing a map for locating a product in a store, the method comprising:
receiving from a user information identifying the product;
retrieving product location information from an inventory table based on the information identifying the product;
determining approximate coordinates for the product based on the product location information with reference to a store layout design, and plotting the approximate coordinates on the map; and
providing the map to the user.

2. The method of claim 1, wherein the store is retail store.

3. The method of claim 1, wherein the store is at least one of a warehouse and a commercial dealership.

4. The method of claim 1, wherein an entry of the inventory table is indexed on a product ID, and the product location information identifies a department and a reference within the department.

5. The method of claim 1, wherein an entry of the inventory table includes the product location information, the product location information identifying a zone for the product, and wherein the approximate coordinates are determined based on the zone for the product.

6. The method of claim 1, wherein upon said receiving the information identifying the product, the information identifying the product is transmitted to a server that performs said retrieving the product location information and said determining the approximate coordinates for the product.

7. The method of claim 1, wherein the approximate coordinates for the product are determined in batch at a time before said receiving the information identifying the product.

8. The method of claim 1, wherein in said providing the map, a location of the user is provided on the map.

9. A product locator system for locating a product in a store, the system comprising:
a location request processor configured to receive from a user kiosk information identifying the product;
a data retriever configured to retrieve product location information from an inventory table based on the information identifying the product;
a coordinates generator configured to determine approximate coordinates for the product based on the product location information with reference to a store layout design, and to plot the approximate coordinates on the map; and
a controller configured to transmit the approximate coordinates to the user kiosk for providing the map based on the approximate coordinates.

10. The system of claim 9, wherein the system is remote from the store.

11. The system of claim 9, wherein the system is located in the store.
